(19) United States
(12) Patent Application Publication
(10) Pub. No.: US 2011/0167035 A1
(43) Pub. Date: Jul. 7, 2011

(54) MULTIPLE-CLIENT CENTRALLY-HOSTED DATA WAREHOUSE AND TREND SYSTEM

(76) Inventors: Susan Kay Kesel, Ocean Springs, MS (US); Colleen Rita Cutler, Manchester, CT (US); Jacquilyn Debra Parker, Ocean Springs, MS (US)

(21) Appl. No.: 12/982,619

(22) Filed: Dec. 30, 2010

Related U.S. Application Data
(60) Provisional application No. 61/292,258, filed on Jan. 5, 2010.

(51) Int. Cl. G06F 17/30

(52) U.S. Cl. 707/602; 707/E17.005; 707/E17.044

(57) ABSTRACT

A system for analyzing data for an industry may include a user that extracts source data from source systems, transforms the source data into key metrics data for a given time period, and loads the key metrics data into a file extract, a data warehouse including data tables that are customized for the industry, a web portal for accepting input of data within the file extract related to the industry, a transformation logic for mapping the data to data elements of one or more of the data tables, and a graphical dashboard that presents in graphical form information specific to the industry based on the data elements of one or more of the data tables.

### CROSS-REFERENCE TO RELATED APPLICATIONS

This application claims the benefit of priority to U.S. provisional patent application No. 61/292,258 filed Jan. 5, 2010, and incorporated herein by reference.

### BACKGROUND OF THE INVENTION

The present invention generally relates to data collection and analysis, and more particularly relates to a multiple-client centrally-hosted data warehouse and trend system for collecting, mapping, and transforming industry-specific data to present trends and metric data.

For companies in every industry, it is important to analyze historical trends as well as to project future trends. To collect the data necessary to produce those trends, a company may need to access multiple systems where the necessary data are kept, and may need to interpret the multitudes of data in order to produce the necessary trend data.

As can be seen, there is a need for a system to streamline, automate, and simplify the gathering of data as well as the production of trend information.

### SUMMARY OF THE INVENTION

In one aspect of the present invention, a method analyzing data for an industry comprises extracting, by a user, source data from source systems; transforming, by the user, the source data into key metrics data for a given time period; loading, by the user, the key metrics data into a file extract; providing data tables that are customized for the industry; accepting input of the file extract; mapping the inputted data to data elements of one or more data tables customized for the industry; generating trends and metrics data relevant to the industry from the data elements of the one or more data tables; and presenting the trends and metrics data.

In another aspect of the present invention, a system for analyzing data for an industry, comprises a user that extracts source data from source systems, transforms the source data into key metrics data for a given time period, and loads the key metrics data into a file extract; a data warehouse including data tables that are customized for the industry; a web portal for accepting input of data within the file extract related to the industry; a transformation logic for mapping the data to data elements of one or more of the data tables; and a graphical dashboard that presents, in graphical form, information specific to the industry based on the data elements of one or more of the data tables.

These and other features, aspects and advantages of the present invention will become better understood with reference to the following drawings, description and claims.

### BRIEF DESCRIPTION OF THE DRAWINGS

FIG. 1 shows a method for analyzing data without a multiple-client centrally-hosted data warehouse and trend system in accordance with an embodiment of the present invention;

FIG. 2 shows a schematic diagram of a multiple-client centrally-hosted data warehouse and trend system in accordance with an embodiment of the present invention;

FIG. 3 shows a method for analyzing data using the multiple-client centrally-hosted data warehouse and trend system of FIG. 2 in accordance with an embodiment of the present invention; and

FIG. 4 shows an exemplary client configuration page for configuring business rules in accordance with an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a multiple-client centrally-hosted data warehouse and trend system for collecting, mapping, and transforming industry-specific data to present trends and metric data.

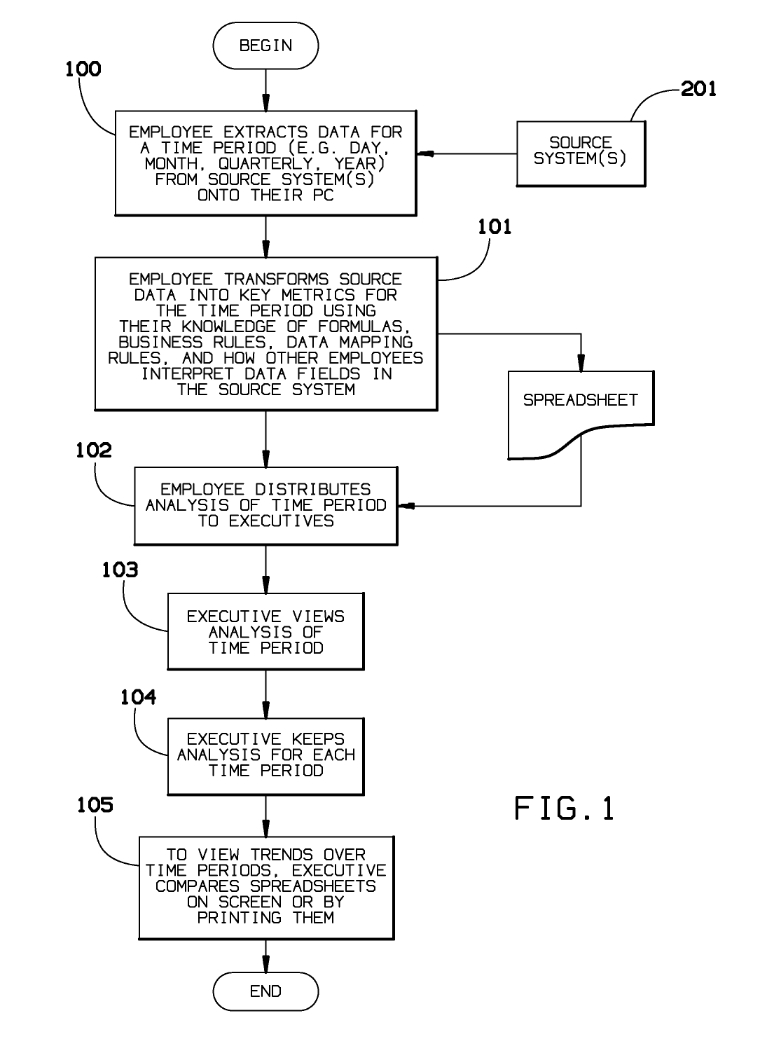

FIG. 1 illustrates a method 110 for analyzing data without the benefit of a multiple-client centrally-hosted data warehouse and trend system. At step 100 of the method 110, a user, such as an employee employed by a client in a specific industry, may extract data for a time period from source systems 201 onto the user's personal computer.

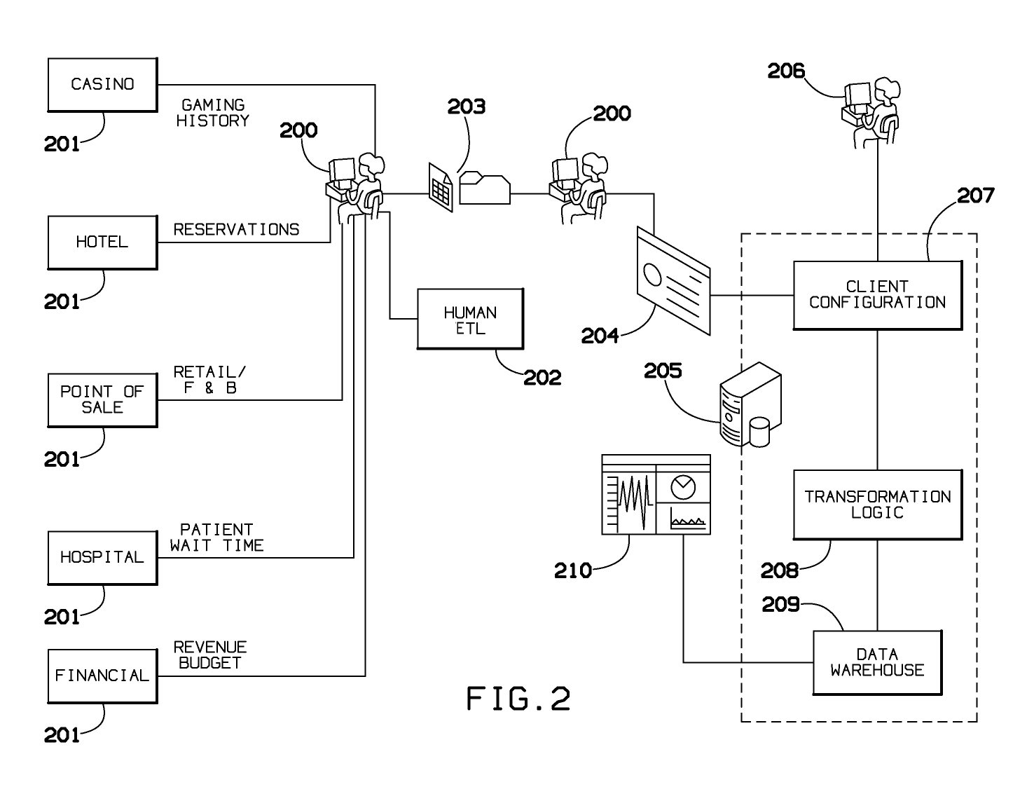

At step 101 of the method 110, the employee may transform the extracted source data into key metrics for the specified time period based on the employee's knowledge. Examples of the utilized knowledge may include formulas, business rules, data mapping rules, and information regarding how other employees may interpret data fields in the source systems. The employee's analysis may be stored in a spreadsheet. Steps 100 and 101 may collectively be referred to as the human extract, transform, and load (Human ETL) method 202 shown in FIG. 2.

At step 102 of the method 110, the employee may distribute the analysis to executives. At step 103 of the method 110, the executives may view the analysis. At step 104 of the method 110, the executive may keep and store the analysis for each time period. At step 105, the executive may compare the analysis of several periods side-by-side to view trends over those periods.

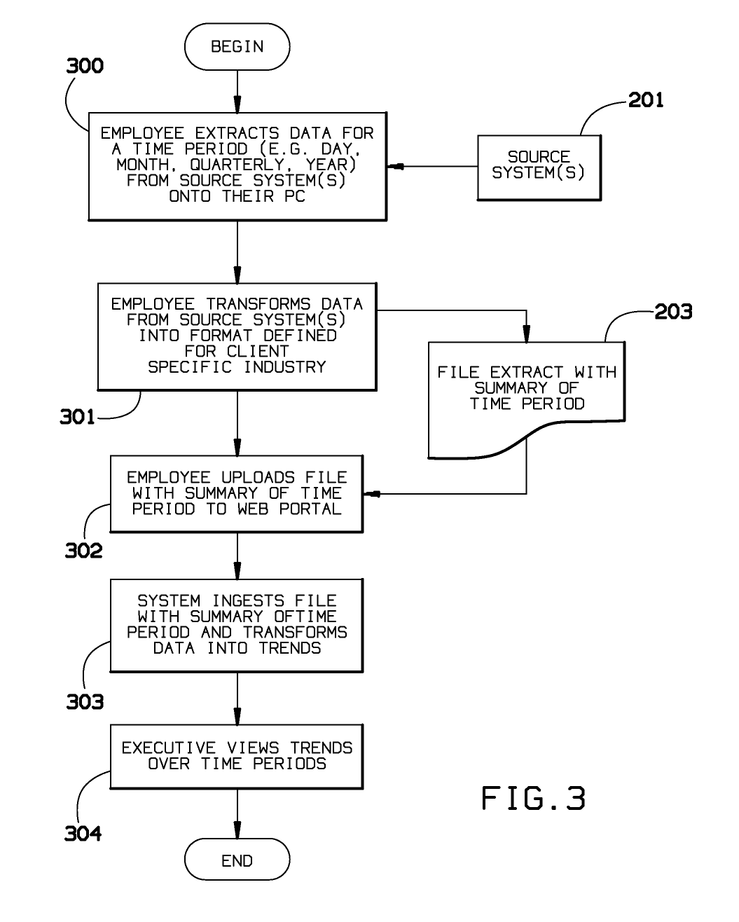

FIG. 3 illustrates a method 330 for analyzing data by using a multiple-client centrally-hosted data warehouse and trend system, in accordance with an embodiment of the present invention. The method 330 is described below with further reference to FIG. 2 illustrating a multiple-client centrally-hosted data warehouse and trend system.

At step 300 of the method 330, a client 200 in a specific industry, may extract data relevant to the client's industry from disparate source systems 201 using human extract, transform, and load (Human ETL) 202 methods. For example, the client may be a casino and the industry may be the gaming industry.

The data extracted from the source systems 201 may be data for a specific event, such as a visit to a hospital or a hotel reservation, or for a specified time period, such as a specified number of days, weeks, months, or years, as well as periods of time defined into quarters. The source systems 201 may, for example, be a casino source system from which gaming history may be extracted, a hotel source system from which reservation information may be extracted, a point of sale source system from which retail information may be extracted, a hospital source system from which patient wait time information may be extracted, and a financial source system from which financial information may be extracted. For a casino in the gaming industry, the source systems 201 may be a casino management system and a slot accounting system from which data regarding information such as the amount of money wagered in a given period of time and the amount of money paid out in the given period of time may be extracted.

At step 301 of the method 330, the client 200 may transform the data extracted from the source systems 201 into file extracts 203 in client-specific and industry-defined formats. Such client-specific and industry-defined formats may be predefined by a party that provides templates or macros that the client 200 may use to create the file extracts The file extracts 203 may be an electronic file, such as a text file, comma separated values file, binary file, spreadsheet, flat file, trigger file, or any other appropriate electronic file format.

For example, in the case of a casino client in the gaming industry, a casino employee may transform the extracted data into file extracts 203 using a pre-defined format predesigned for the gaming industry and furnished by the provider of the multiple-client centrally-hosted data warehouse and trend system. The pre-defined format may, for example, include fields for players' account numbers, number of visits, zip code of the players' addresses, theoretical loss amount for the players during a future visit, gender of the players, employee assigned to host the players, players' date of birth, and date of last visits. The casino employee may be able to generate file extracts 203 with the extracted data in the predefined format.

At step 302 of the method 330, the client 200 may upload the file extracts 203 to a server system 205 via a web portal 204 which may be accessible via a web browser. The server system 205 may include a plurality of servers to provide redundancy and may be networked with secure access to the Internet. The web portal 204 may include client login pages for the client 200 to log into the system. Upon being logged in, the web portal 204 may provide client upload pages for uploading the file extracts 203. The client upload pages may be part of a wizard that may accept the file extracts 203 and that may map the file extracts to data elements of industry-specific tables in the data warehouse 109 with the aid of transformation logic 208.

The web portal 204 may alert the client 200 of possible duplicate or erroneous data. For example, if the client 200 puts the number of visits into a column for the date of birth, the web portal 204 may provide an error message with a detailed description of the problem and of the erroneous data.

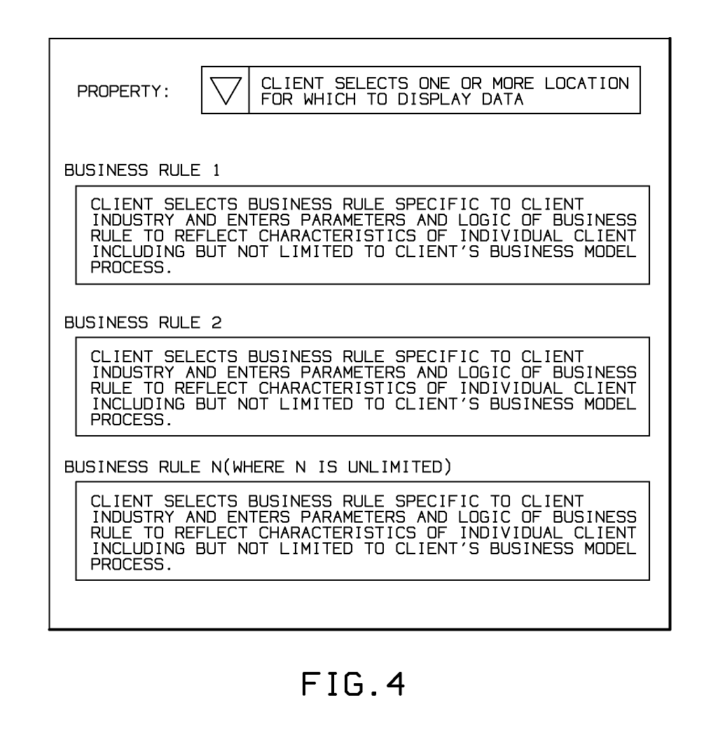

The web portal 204 may also provide client configuration pages that may allow users to configure and specify business rules 206 for controlling behavior of the server system 205, and which may be stored on a client configuration table 207. FIG. 4 shows an example of a client configuration page of the web portal 204 for configuring the business rules 206. Via the client configuration page, a user may be able to select one or more locations for which to display data, and may also be able to select one or more business rules specific to a client industry and may be able to enter parameters and the logic of the business rule to reflect characteristics of the individual client. Such characteristics may include but is not limited to the client's business model process.

For example, in the context of the casino client in the gaming industry, the casino may specify and define business rules 206 about the number of visits per month that is considered “Daily”, “Weekly”, and “Monthly”, the drive time in hours that is considered “Local Market”, “Regional Market”, or “National Market”, the range of values in a theoretical loss that is considered “Low Player”, “Medium Player”, and “Good Player”, and the range of time since the last visit to be considered “Recent”, “Due Back”, “Over Due”, and “Inactive”. Each casino may be able to specify business rules 206 and the name(s) of their individual rules. One casino may refer to a “Low Player” while another casino may refer to “Segment 10”. Each casino may also have a different number of business rules 206. For example, another casino may have another category called “Excellent Player”.

The client configuration pages may also allow users to configure, fill in, or otherwise utilize other tables within the server system 205, such as a contract table, a products table, a property table, a subscription table, a clients table, a client user table, and a client user property table.

The data from the uploaded file extracts 203 may be held in staging tables for auditing before it is stored into the data warehouse 209. Transformation logic 208 may take the data from the staging tables and map them to data elements of industry-specific tables within the data warehouse 209 based on the business rules 206. In the context of the casino client in the gaming industry, the transformation logic 208 may, based on the specified business rules 206, use data in the file extracts 203 regarding the number of visits to classify a player as “Weekly”, use data in the file extracts 203 regarding the home zip code to classify a player as “Local Market”, use data in the file extracts 203 regarding the theoretical loss to classify a player as “Good Player”, use data in the file extracts 203 regarding the date of the last visit to classify a player as “Due Back”, and use data in the file extracts 203 regarding the date of birth to calculate the age of a player.

The data warehouse 209 may contain a number of data tables having pre-specified data elements or fields for a variety of industries. For the casino client in the gaming industry, an industry-specific data table may have data elements to store the classification of players for the casino. For example, the transformation logic 208 may, based on a specified business rules 206, use the number of visits to classify a player as “Weekly”, use the home zip code to classify a player as “Local Market”, use the theoretical loss to classify a player as “Good Player”, use the date of the last visit to classify a player as “Due Back”, and use the date of birth to calculate the age of a player. Such classifications and calculations may then be stored in a gaming industry-specific data table.

At step 303 of the method 330, once the industry-specific tables within the data warehouse 209 have been populated by the transformation logic 208, information such as historical and/or projected trend data and metrics 210 over a specified time period for the client's industry may be produced and presented based on the data contained within the data warehouse 209.

At step 304 of the method 330, the trend data and metrics 210 may be presented as charts, graphs, tables, numbers, words, or any other suitable method of presentation, and may be viewed, printed, or downloaded using one or more web dashboards that are accessible using a computer, personal digital assistant, tablet computer, smartphone, or any other web-enabled device by an executive. Industry-specific subsets of the trend data and metrics 210 may be selected and viewed by a viewer based on business rules 206 or any other suitable criteria.

Alternatively, industry-specific subsets of the trend data and metrics 210 may be specified and downloaded so that industry-relevant action may be taken based on the trend data and metrics 210, such as creating direct marketing campaigns, advertising campaigns, and promotional offers.

In the context of the casino client in the gaming industry, the casino may be able to view the trend data and metrics using custom pre-constructed dashboards that are specific to the gaming industry. For example, the casino client may be able to view the following trends:

| | |
|---|---|
| Trend 1 | Over the last six months, players who live in the “Local |
| | Market” had been coming “Weekly” but are tending to come |
| | “Monthly”, and an increasing percentage of the “Good Players” |
| | are “Over Due”. |
| Trend 2 | Over the last 12 months, the players who are aged 20-29 years |
| | old, and live in the “Regional Market”, had been coming |
| | “Monthly” but have been tending to come more often but |
| | lose less money. |
| Trend 3 | Over the last 3 months, the “Very Good” players being taken |
| | care of by a host called “Smith” have been tending to come less |
| | often but gamble more money on each visit, and the players |
| | being taken care of by a host called “Jones” have been coming |
| | more frequently, especially those in the “Local Market”, but |
| | have been gambling less money, on average, than the players |
| | being taken care of by “Smith” |

The casino client may also be able to filter the data and may be able to compare the difference, for example, in behavior by players who prefer to play slot machines to players who prefer to play table games. For example, the casino client may be able to see a trend for players aged 20-29 moving from card games to slot machines over the last 24 months, but that “Good Players” of all ages who live in the “National Market” and visit “Monthly” have consistently preferred to play table games.

It should be understood, of course, that the foregoing relates to exemplary embodiments of the invention and that modifications may be made without departing from the spirit and scope of the invention as set forth in the following claims.

We claim:

1. A method for analyzing data for an industry, comprising:
extracting, by a user, source data from source systems;
transforming, by the user, the source data into key metrics data for a given time period;
loading, by the user, the key metrics data into a file extract;
providing data tables that are customized for the industry;
accepting input of the file extract;
mapping the inputted data to data elements of one or more data tables customized for the industry;
generating trends and metrics data relevant to the industry from the data elements of the one or more data tables; and
presenting the trends and metrics data.

2. The method of claim 1, wherein the generating includes producing the trends and metrics data from a subset of the one or more of the data tables according to business rules.

3. The method of claim 1, wherein the presenting includes presenting a graphical representation of the trends and metrics data.

4. The method of claim 3, wherein the graphical representation comprises graphical dashboards.

5. The method of claim 1, wherein the transforming by the user is based on the user's knowledge of at least one or more of formulas, business rules, data mapping rules, and information regarding how other users may interpret data fields in the source systems.

6. The method of claim 1 further comprising providing a wizard to accept the input of data by the user and to map the inputted data into the data elements of the one or more of the data tables.

7. The method of claim 1, wherein the mapping the inputted data includes translating the inputted data from a first form to a second form.

8. The method of claim 1, wherein the one or more of the data tables comprises one or more of a contract table, a products table, a property table, a subscription table, a clients table, a business rule table, a client user table, and a client user property table.

9. The method of claim 1, further comprising transforming the data elements of the one or more data table into actionable information for the industry.

10. A system for analyzing data for an industry, comprising:
a user at a company that
extracts source data from source systems,
transforms the source data into key metrics data for a given time period, and
loads the key metrics data into a file extract;
a data warehouse including data tables that are customized for the industry;
a web portal for accepting input of data within the file extract related to the industry;
a transformation logic for mapping the data to data elements of one or more of the data tables; and
a graphical dashboard that presents, in graphical form, information specific to the industry based on the data elements of one or more of the data tables.

11. The system of claim 10, wherein the data warehouse includes a plurality of data tables that are customized for a plurality of industries.

12. The system of claim 10, wherein the information includes historical trends and metrics specific to the industry.

13. The system of claim 10, wherein subsets of the information is user-selectable and is presentable by the graphical dashboard.

14. The system of claim 13, wherein the subsets of the information is selected by applying business rules of a client.

15. The system of claim 10, wherein the graphical dashboard is operable to filter the information based on a choice of pre-defined options.
